(19) United States
(12) Patent Application Publication
(10) Pub. No.: US 2009/0271371 A1
(43) Pub. Date: Oct. 29, 2009

(54) SEARCH CUSTOMIZATION BY GEO-LOCATED PROXY OF USER SEGMENT

(76) Inventors: Alan Levin, Vancouver (CA); Min San Co, Jersey City, NJ (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/111,065

(22) Filed: Apr. 28, 2008

(51) Int. Cl. G06F 17/30

(52) U.S. Cl. 707/3; 707/E17.108

(57) ABSTRACT

A system and method of data processing receives a query at a server computer system. The system and method utilizes the query to extract a search result from a data source. The system and method associates the search result with a geographically distributed population. The system and method associates a demographic criteria with the geographically distributed population and processes the search result to create an output data set based on the demographic criteria. The system and method transmits the output data set from the server computer system to the client computer system.

### CROSS-REFERENCE TO RELATED APPLICATIONS

This application is related to U.S. patent application Ser. No. 10/853,552 entitled “METHODS AND SYSTEMS FOR CONCEPTUALLY ORGANIZING AND PRESENTING INFORMATION,” by Curtis, et al., filed on May 24, 2004, which is hereby incorporated herein by reference.

### BACKGROUND OF THE INVENTION

1). Field of the Invention

Embodiments of this invention relate to a data processing system and method that provides demographically biased search results.

2). Discussion of Related Art

The internet is a global network of computer systems and has become a ubiquitous tool for finding information regarding news, businesses, events, media, etc. in specific geographic areas. A user can interact with the internet through a user interface that is typically stored on a server computer system.

Because of the vast amounts of information available on the Internet, users often enter search queries into a search box for processing by a server computer system. The server computer system typically searches a database of information to extract and provide for the user. Unfortunately, a large amount of irrelevant information is often provided to the user which can result in the user being overwhelmed.

Often times, certain search results will appeal to some segments of the user population more than other segments. For example, a page about a retirement community might appeal to elderly users more than to children. Tailoring results to a given segment could increase the subjective relevance of a search result and offer a user an experience customized to their preferences and interests.

### SUMMARY OF THE INVENTION

The invention provides a method of data processing including receiving a query from a client computer system over a network at a server computer system and utilizing the query to extract at least one search result from a data source.

The method of data processing may further include associating the at least one search result with a geographically distributed population.

The method may further include associating at least one demographic criteria with the geographically distributed population and processing the at least one search result to create at least one biased search result based on the at least one demographic criteria.

The method may further include transmitting the at least one biased search result from the server computer system to the client computer system.

The method may further include wherein the processing of the at least one search result is accomplished by a geo-bias process. The geo-bias process may include determining demographic hits for at least one URL by summing a product of a percentage of a population in at least one geographic location that fits the demographic criteria and a number of hits for the at least one URL.

The method may further include wherein the geo-bias process determines a bias ratio for a URL based on expected hits and the demographic hits to determine whether a URL is uniquely relevant to a demographic segment fitting the demographic criteria.

The invention provides a method of data processing including receiving a first query from a first group of client computer systems at a server computer system and receiving a second query from a second group of client computer systems at the server computer system.

The method may further include utilizing the first and second query to extract at least one search result from a data source and receiving an identification of each client computer system.

The method may further include associating the at least one search result with a geographically distributed population and associating at least one demographic criteria with the geographically distributed population.

The method may further include processing the at least one search result to create a first output data set and second output data set based on the at least one demographic criteria.

The method may further include transmitting a first output data set from the server computer system to the first group of client computer systems and transmitting a second output data set from the server computer system to the second group of client computer systems.

The method may further include wherein the first output data set and second output data set are the same because the first group of client computer systems and second group of client computer systems have the same geographically distributed user population.

The method may further include wherein the first and second group of client computer systems are located in different geographic locations.

The method may further include wherein the first and second group of client computer systems are located in the same geographic location

The invention provides machine-readable storage medium that provides executable instructions which, when executed by a computer system, causes the computer system to perform a method including receiving a query from a client computer system over a network at a server computer system.

In the machine-readable storage medium, the computer system may execute the method further including utilizing the query to extract at least one search result from a data source and receiving an identification of the client computer system.

In the machine-readable storage medium, the computer system may execute the method further including associating the at least one search result with a geographically distributed population and associating at least one demographic criteria with the geographically distributed population.

In the machine-readable storage medium, the computer system may execute the method further including processing the at least one search result to create at least one biased search result based on the at least one demographic criteria and transmitting the at least one biased search result from the server computer system to the client computer system.

In the machine-readable storage medium, the computer system may execute the method further including receiving a first query from a first group of client computer systems at a server computer system and receiving a second query from a second group of client computer systems at the server computer system.

In the machine-readable storage medium, the computer system may execute the method further including utilizing the first and second query to extract at least one search result from a data source and receiving an identification of each client computer system.

In the machine-readable storage medium, the computer system may execute the method further including associating the at least one search result with a geographically distributed population and associating at least one demographic criteria with the geographically distributed population.

In the machine-readable storage medium, the computer system may execute the method further including processing the at least one search result to create a first output data set and second output data set based on the at least one demographic criteria.

In the machine-readable storage medium, the computer system may execute the method further including transmitting a first output data set from the server computer system to the first group of client computer systems and transmitting a second output data set from the server computer system to the second group of client computer systems.

In the machine-readable storage medium, the computer system may execute the method further including wherein the first output data set and second output data set are the same because the first group of client computer systems and second group of client computer systems have the same geographically distributed user population.

The invention provides a system for processing data including a server computer system and a module stored on the server computer system for receiving a query.

The system for data processing may further include a search engine that utilizes the query to extract at least one search result from a data source and an identification module to receive an identification of the client computer system.

The system for data processing may further include a geographic module for associating the at least one search result with a geographically distributed population and for associating at least one demographic criteria with the geographically distributed population.

The system for data processing may further include a processing module for processing the at least one search result to create at least one ranked output data set based on the at least one demographic data.

The system for data processing may further include a transmission module to transmit the at least one ranked output data set, based on the at least one demographic criteria from the server computer system to the client computer system.

### BRIEF DESCRIPTION OF THE DRAWINGS

The invention is further described by way of example with reference to the accompanying drawings, wherein:

FIG. 1 is a block diagram illustrating a data processing system;

FIG. 2a is a block diagram illustrating a data processing system method;

FIG. 2b is a block diagram illustrating a geo-bias processing method;

FIG. 3 is a flowchart illustrating how a geo-bias is applied;

FIG. 4 is a screenshot of search results;

FIG. 5 is a block diagram of a network environment in which a user interface according to an embodiment of the invention may find application;

FIG. 6 is a flowchart illustrating how the network environment is used to search and find information; and

FIG. 7 is a block diagram of a client computer system forming area of the network environment, but may also be a block diagram of a computer in a server computer system forming area of the network environment.

### DETAILED DESCRIPTION OF THE INVENTION

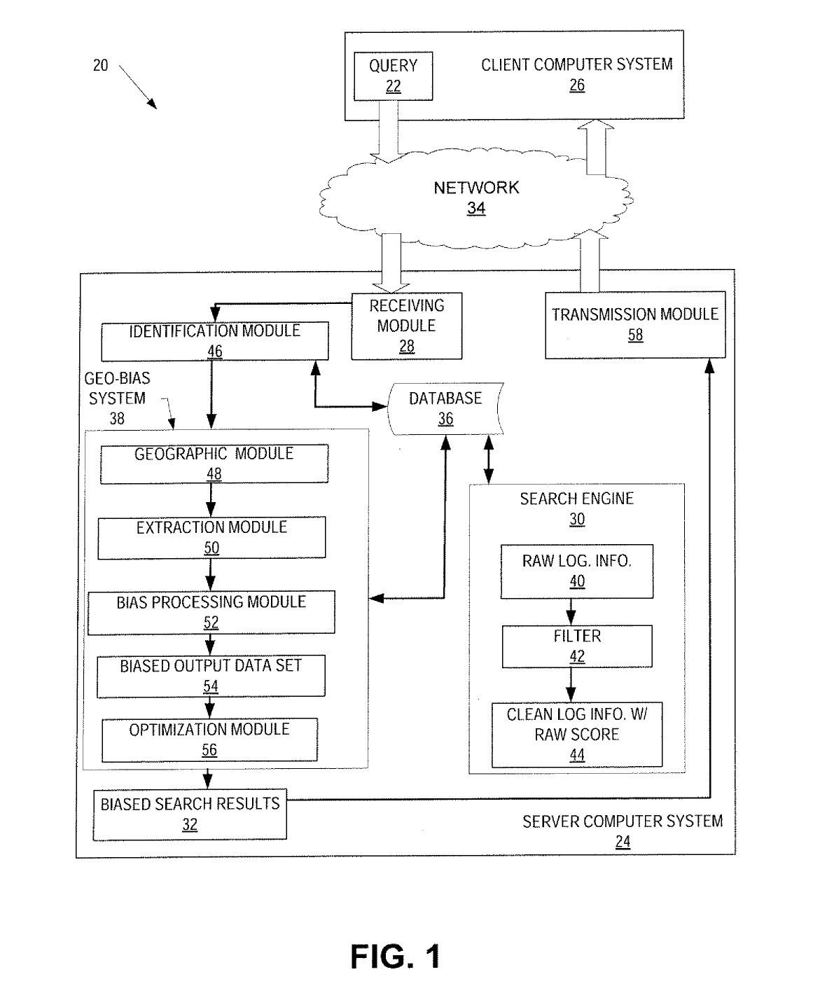

FIG. 1 of the accompanying drawings illustrates a data processing system 20 that includes a server computer system 24, a client computer system 26, and a network 34, according to an embodiment of the invention.

The server computer system 24 includes a receiving module 28, an identification module 46, a geo-bias system 38, a database 36, a search engine 30, and a transmission module 58.

The receiving module 28 is connected with the identification module 46 and network 34. The receiving module 28 receives a query 22 from the client computer system 26 through the network 34. The identification module 46 is connected with the receiving module 28, database 36, and geo-bias system 38.

The geo-bias system 38 includes a geographic module 48, an extraction module 50, a bias processing module 52, and optimization module 56. The geo-bias system 38 is connected with the identification module 46, the database 36, and the transmission module 58.

The transmission module 58 is connected with the geo-bias system 38 and the network 34. The network 34 is connected with both the transmission module 58 and client computer system 26.

The search engine 30 includes raw log information 40, a filter 42, and clean log information with raw scores 44. The filter 42 receives raw log information 40 and produces clean log information 44. Because the search engine 30 is connected with the database, the clean log information 44 is stored at database 36. Raw log information 40 includes recorded user interactions with the search engine 30. The raw log information 40 is a record of user clicks on links of a web page. Search engine 30 activity can be continuously or non-continuously recorded as raw log information 40. The search engine 30 can be of the type described in U.S. application Ser. No. 10/853,552, the contents of which are hereby incorporated by reference.

The clean log information 44 is correlated according to Query-to-Pick history data. Query-to-Pick history data refers to the correlation between a query entered by a user and the URL picked (hereinafter “picks”) by the user. According to the Query-to-Pick History, a raw score is assigned to each URL pick by any scoring method. The URL picks are ranked according to the raw score and stored in the database 36.

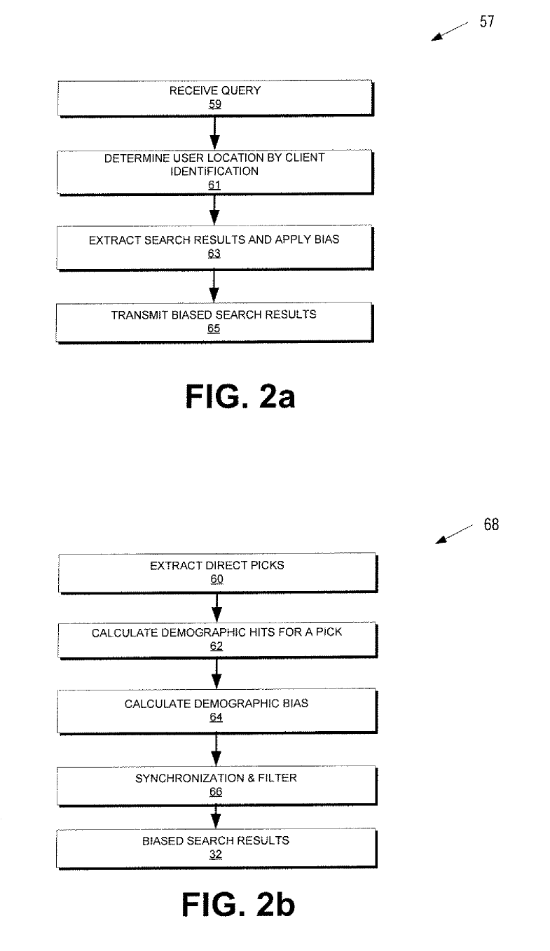

In use, FIG. 2a shows a data processing system method 57. The query 22 is received 59 by the receiving module 28. The query 22 is a general input and can be a search query received from the client computer system 26. However, the query 22 is not necessarily a search query but can be words extracted or crawled from a web document or stored document. It is understood that the query 22 is alternatively multiple queries from multiple geographic regions instead of a single query 22 from one geo-location.

The identification module 46 receives the query 22 from the receiving module 28 along with any information related to the query 22. The geographic location (hereinafter “geo-location”) of the user is determined 61 by an identification of the client computer system 26. The identification of the client computer system (hereinafter “client identification”) is a specific Internet Protocol address (IP address). In addition, the client identification can be a user identification (user ID) having a geo-location associated with the user ID.

The identification module 46 determines the client identification by referring to information located on the database 36 to obtain the geo-location of the client computer system 26.

The identification module 46 associates a geo-location with the client identification and transmits the geo-location of the users client identification information, and query 22 to the geo-bias system 38.

Of course, it is understood that the geo-bias system 38 can operate independently without receiving the client identification or geo-location of the user. For example, a user can access a website that automatically applies the geo bias system 38 to produce biased search results depending on the targeted demographic of the website. In another example, the user may request or select an option to utilize the geo-bias system 38 without the need for identifying the user's geo-location.

In the example illustrated in FIG. 2a, the geo-bias system 38 receives the geo-location of the client computer system 26, client identification, and query 22. It is understood that the query 22 can be indirectly received at the geo-bias system 38 through the search engine 30.

FIG. 2a further shows the extraction 63 of search results and a bias being applied to the search results. The geo-bias system 38 utilizes the query 22 to extract 63 at least one search result from the database 36 to apply a bias. Applying a bias to the search results produces biased search results 32.

Once the bias is applied to the raw scores of ranked URLs, the biased search results 32 are received by the transmission module 58 and transmitted 65 to the client computer system 26 through the network 34. Therefore, the biased search results 32 produced by the geo-bias system 38 are tailored to match the demographic criteria of the user.

FIG. 2b illustrates the overall geo-bias process 68 within the geo-bias system 38 that produces biased search results 32. The geo-bias system 38 extracts 60 ranked URL picks 78 (hereinafter “direct picks”), calculates demographic hits 62 for a URL pick 78, calculates a demographic bias 64 in a region, and synchronizes and optimizes 66 a biased output data set 54 to produce biased search results 32.

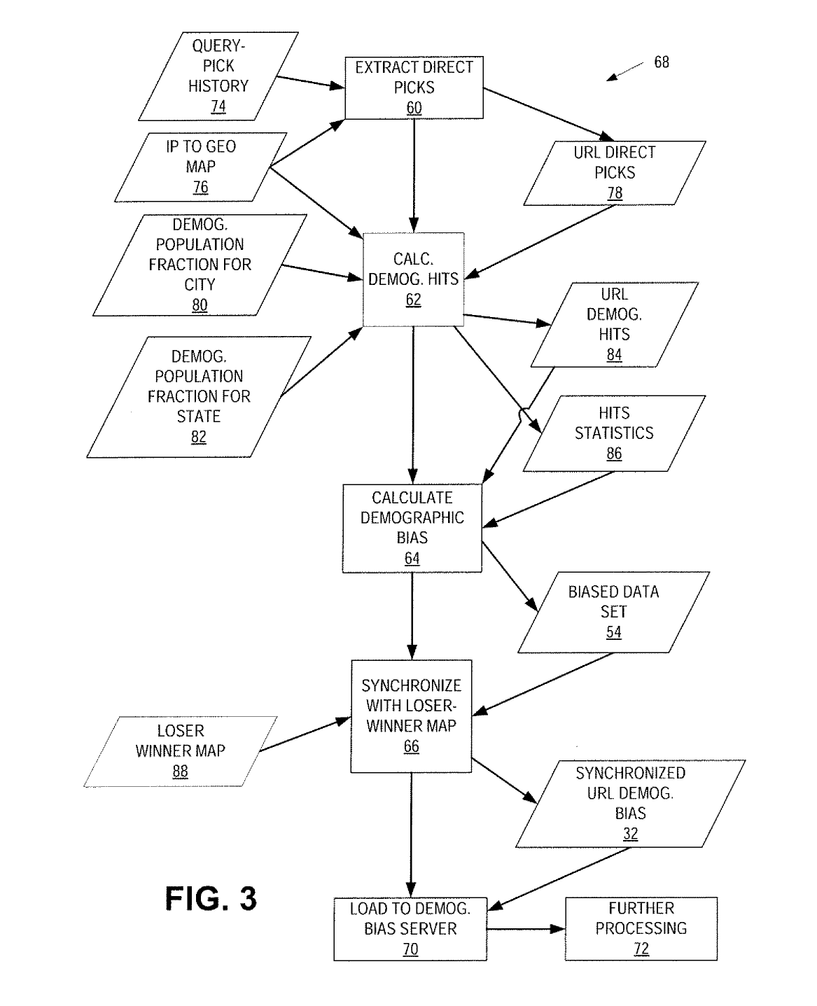

FIG. 3 shows a flow chart involving the geo-bias process 68. The geo-bias system 38 includes the geographic module 48 for mapping IP addresses to a specific geo-location. The geographic module 48 is used to find the geo-location of users who have logged picks in the Query-Pick database 36. The geographic module 48 creates an IP-to-Geo Map 76 which is used to locate the geo-location of an IP address.

As previously mentioned, the geo-bias system 38 includes the extraction module 50 that extracts 60 and obtains unique and direct picks 78 or search results from the database 36 in response to the user query 22. The geo-bias system 38 will use the extracted direct picks 78 or search results to create biased search results 32.

The extraction module 50 scans through a Query-Pick history 74 file from database 36 for direct pick information. The extraction module 50 converts IP address information from the Query-Pick history 74 file to a geographic ID using the IP-to-Geo-map 76. The geographic ID (herein after “geo-ID”) is a code number that represents a single place name in the Query-Pick history files for efficiency purposes. In addition, the extraction module 50 can extract a URL host ID, a user ID, and an un-stemmed query ID for each pick. The extraction module 50 removes duplicate records by sorting the records by various IDs and eliminating records having the same ID. Therefore, the direct picks 78 or search results are associated with a geographically distributed population through the IP address information and by the use of a geo-ID.

FIG. 3 further shows the geo-biasing system 38 calculating 62 demographic hits 84. Demographic hits 84 are an estimated number of how many picks of a specific URL occur from users that fit a demographic criteria or user segment. The demographic hits 84 can be estimated over several geo-locations or one geo-location for a specific URL.

The demographic hits 84 are determined for each direct pick 78 or search result. The demographic hits 84 calculation for each direct pick 78 requires demographic population census data for each geographic ID, and data describing the number of hits per URL. An illustrative example of calculating the demographic hits 84 is provided below.

Initially, census data is obtained from a database and can provide information similar to the example in Table 1.

TABLE 1
Census Data

| Zip | | | White | Black | Hispanic | Asian | Other | | |
|---|---|---|---|---|---|---|---|---|---|
| Code | Pop | Households | Pop. | Pop. | Pop. | Pop. | Pop. | City | State |
| 45433 | 3140 | 793 | 2512 | 400 | 105 | 70 | 35 | Dayton | Ohio |

The above census data is an example of the type of census data that can be obtained for calculating a demographic hit 84 for a URL. The above census data indicates the zip code, population, and other demographic variables for the geographic location of a city and state such as Dayton, Ohio. It is understood that many other types of data can be gathered from the census data such as household size, income, political party affiliation, property values, and gender on a town, city, or state basis. From the census data, the percentage of users fitting a certain demographic criteria within a city 80 and state 82 can be extracted to calculate 62 demographic hits 84.

Table 2 provides an example of demographic data that is used to calculate demographic hits 84 for a specific URL pick 78 from the Query-Pick History 74 file. In one illustrative example, suppose the census data shows the following percentages of a population that fits a certain demographic criteria for the listed cities.

TABLE 2
Census Data and Hits/Clicks

| | Percentage of | |
|---|---|---|
| | Population that Fits a | Number of Hits for a |
| City | Demographic Criteria | Specific URL |
| Salt Lake | 1% | 100 |
| City | | |
| San Francisco | 10% | 200 |
| Atlanta | 40% | 500 |
| Detroit | 80% | 1000 |

As shown in Table 2, a particular URL logs the above number of hits or clicks associated with the cities 80 listed. The total number of clicks for the specific URL in Table 2 is 1800 (100+200+500+1000) clicks. By summing the product of the percentage of the population in at least one geographic location (resulting in a geographically distributed population) that fits a demographic criteria and the number of hits for a URL, a demographic hits value 84 is calculated. A Demographic_Hits value is a calculated number representing the number of probable clicks from a demographic group based on the Census data and geographic ID. The following equation can be used to determine the demographic hits 84:

Demographic_Hits=Σ(Percent)(Number_of_Hits)

In the illustrative example, the above formula with respect to the data contained in Table 2 would produce the following result:

Demographic_Hits=(1%)(100)+(10%)(200)+(40%)(500)+(80%)(1000)=1021

The demographic hits 84 value is calculated as a value of 1021. In the geographic areas of Salt Lake City, San Francisco, Atlanta, and Detroit, the estimated number of clicks from users matching a specific demographic criteria is one thousand twenty-one clicks. The clicks are summarized over a plethora of varied locations to eliminate local biases and retain the common biases that link the diverse source locations. Therefore, a geographically distributed population is associated with at least one search result or click while eliminating any local biases that may exist.

A local bias is present when a URL happens to be locally popular in a geographic location having a high density of users matching a demographic criteria. A URL having a local bias (instead of demographic bias) means that the amount of clicks are unrelated to the demographic criteria but rather related to a local preference. Therefore, URLs having a local bias can be eliminated from the Demographic_Hits calculation.

FIG. 3 further shows a demographic bias ratio being calculated 64 based on the demographic hits 84 value and overall expected hits 86. The “expected” clicks of a user are calculated based on the sum of all demographic clicks in the database as a percentage of all total clicks.

The bias processing module 52 calculates 64 a demographic bias ratio. The bias ratio indicates whether a specific URL is significant to users that have a specific demographic criteria in common.

Returning to the illustrative example presented in Table 2, assume the expected total click or hit percentage for a specific demographic is 15% (all demographic clicks in the database 36 divided by all total clicks in the database 36). Thus, the bias ratio can be calculated using the formula:

$$Bias\_Ratio = {( \frac{Demographic\_Hits + AdjustmentFactor 1}{Expected\_Hits + AdjustmentFactor 2} )}^{damping\_factor}$$

The Bias_Ratio is a ratio between the demographic hits located in the numerator and expected hits in the denominator. Adjustment factors (AdjustmentFactor1, AdjustmentFactor2) are added to the demographic hits and expected hits and can be defined by an administrator of the geo-bias system 38. The adjustment factors are added to prevent a huge bias from occurring with very few clicks. The adjustment factors prevent false biasing. The adjustment factors can be the same or different values. It is understood that an embodiment without the adjustment factors can be created.

The volume of clicks is an important factor in determining the reliability of a bias ratio. The confidence in a bias ratio based on a handful of clicks would be low. For example, the adjustment factors would be relevant where the Expected_Hits or expected number of clicks is much less than one. If there were only one Demographic_Hits or click and no adjustment factor when the Expected_Hits is less than one, then the bias ratio of the Demographic_Hits to Expected_Hits would be undeservedly huge.

On the other hand, if zero Demographic_Hits were recorded, the ratio would always be zero which may be unfair treatment for a URL with very few clicks. The adjustment factor used in both numerator and denominator is 1.0 in order to solve the situation where very little data is available. The adjustment factor could be larger if desired to prevent sparse data from having much impact on bias.

The damping factor in the bias ratio equation is defined by the equation below:

$$Damping\_Factor = 1 - ( \frac{1}{1 + LogBase ( U )} )$$

The variable “U” in the above equation can range from one to millions. Therefore, the damping factor ranges from zero (when U=1) to nearly one (when U is large). When U is large, there is a high confidence that bias ratio truly represents the user's will. If U is small, the ratio may be a statistical effect and therefore is not given much weight. The damping factor prevents sparse data from having much impact on the bias ratio.

Thus, with respect to the illustrative example shown in Table 2, the demographic hits and the expected hits are used to calculate the bias ratio (ignoring adjustment factors and damping factor in this example for ease of illustration).

$$Bias\_Ratio = \frac{( 1021 )}{( ( 1800 ) ( \% 15 ) )} = 3.78$$

Excluding the adjustment factors and damping factor, the calculated bias ratio for the data provided in Table 2 is 3.78 indicating that the specific URL is likely to be more relevant to a user matching the specified demographic criteria. If the calculated bias ratio were closer to a value of one or less, then the specific URL is deemed not particularly relevant to the users matching the demographic criteria because the Expected_Hits would match the Demographic_Hits.

In another illustrative example, if the data in Table 2 represents the percentage of African-Americans in the geo-locations listed, the Demographic_Hits for African-Americans is statistically estimated based on the U.S. Census data. Assuming the expected percentage of African-American clicks is 15% (because 15% of all total clicks in the entire database are statistically from African-Americans), then the calculated ratio of 3.78 would indicate that a URL is probably very relevant to African-American users.

In another example, suppose a URL received 1000 clicks in total and the African-American population was expected to generate 10% of all clicks. Therefore, a total of 100 African-American clicks are “expected” for a neutral URL (10%*1000). However, suppose the statistical weights were summed in a geographic location for each click and yielded an estimated 221.5 African-American clicks (demographic hits) for this URL. The bias ratio, in this example, would be 2.215 (the result of 221.5/(1000*10%)). A bias ratio of 2.215 would indicate significantly elevated interest in this URL among the African-American segment. Therefore, the raw scores of ranked URLs 44 would be adjusted as described in further detail below.

Once the bias ratio (Bias_Ratio) is calculated, the bias ratio can be applied to the raw scores of ranked URLs 44 produced from the search engine 30 and stored in the database 36. The bias ratio can be applied to the raw score 44 using either of two formulas.

Formula1_Bias=(Bias_Ratio^{P})(RawScore)

Formula2_Bias=(RawScore)^{(Q•Bias}^{_{Ratio)}}

The variables P (in Formula 1) and Q (in Formula 2) are gain factors that can be chosen by an administrator of the geo-bias system 38. It is understood that the P and Q factors can be adjusted by an end user so that the end user can turn up or down the effect of the bias. In a geo-bias system 38 where the bias ratio has a maximum value of 2.5, simply multiplying the bias ratio with the raw score of ranked URLs 44 would not have the ability to bring up desirable results from deep within the raw scoring 44 list which may have raw scores several orders of magnitude less than the top results.

The variables P and Q act as amplification factors and are adjustable within both formulas. In the African-American example, P has a preferred value of about five and Q has a preferred value of about one in order to avoid too much irrelevant content from entering the biased search results 32.

The data sets provided in Tables 3, 4, and 5 below illustrate how the bias ratio and bias formulas effect a raw score 44 for an African-American demographic bias.

TABLE 3
Raw Click-scored - Top Ten Unbiased Search Results for “hair care”

| Raw | Query: hair care | Raw |
|---|---|---|
| Rank | URL | Score |
| 1 | http://www.hairboutique.com/ | 165227 |
| 2 | http://www.free-beauty-tips.com/ | 133949 |
| 3 | http://www.hairboutique.com/tips/tip078.htm | 90145 |
| 4 | http://www.salonweb.com/ | 84546 |
| 5 | http:/www.4everideas.com/hair-care-tip.html | 63442 |
| 6 | http://www.webindia123.com/women/Beauty/ | 59417 |
| | Hair/nature.htm | |
| 7 | http://www.healthyhairplus.com/ | 56199 |
| 8 | http://www.hair-styles.org/ | 39155 |
| 9 | http://www.hairboutique.com/tips/tip214.htm | 22486 |
| 10 | http://www.blackhaircare.com/ | 20427 |

Table 3 shows an unbiased data set for the query “hair care”. The results in Table 3 are not targeted for a specific demographic and therefore are not biased. The results provided in Table 3 are unspecific to African-Americans and therefore an African-American user may have to click through many links to find a relevant URL.

The raw rank is shown in the first column followed by the URL located in the second column. The third column indicates the raw score 44 by which the raw rank is determined. It is understood that the search results in Table 3 will extend beyond the top ten results (up to 100 or more) shown for the query “hair care”. However, only the top ten results are described in Tables 3, 4, and 5 for illustrative purposes.

TABLE 4
Formula 1 - Top Ten Biased Search Results for “hair care”

| | | Biased | |
|---|---|---|---|
| Original | Query: hair care | Score | |
| Rank | URL (Formula 1) | (Formula 1) | Bias |
| 10 | http://www.blackhaircare.com/ | 73539 | 1.292 |
| 18 | http://www.jazma.com/ | 67239 | 1.3996 |
| 24 | http://www.blackhairmedia.com/ | 61871 | 1.433 |
| | hairstyles.htm | | |
| 1 | http://www.hairboutique.com/ | 54515 | 0.8011 |
| 28 | http://www.nappturality.com/ | 50763 | 1.3991 |
| 23 | http://members.aol.com/horizon011/ | 48558 | 1.3412 |
| | hair/index.html | | |
| 6 | http://www.webindia123.com/women/ | 38927 | 0.9189 |
| | Beauty/Hair/nature.htm | | |
| 7 | http://www.healthyhairplus.com/ | 38325 | 0.9263 |
| 26 | http://www.nappyhair.com/ | 37387 | 1.3075 |
| 4 | http://www.salonweb.com/ | 30964 | 0.818 |

Table 4 illustrates an African-American biased output data set 54 for the query “hair care” using the Formula 1 described above. In this example, the P factor is about five. The results in Table 4 are ranked in descending order from top to bottom based on the biased score applied through Formula 1 (column 3). Because of the Formula 1 bias, the URL that would ordinarily be ranked as number ten, is now ranked number one. Therefore, an African-American user searching the internet for hair care products will be more likely to find a URL link that is relevant to his or her preferences.

The first column in Table 4 indicates the original unbiased scoring provided to each URL and the second column shows the URL being ranked. The third column shows the biased score resulting from Formula 1 and the fourth column shows the bias ratio used in calculating the Formula 1 biased score.

It should be noted that the re-ranking of Table 4 shows much more demographic focused content and has pulled results from deep within the top one-hundred results provided in the raw score 44.

For example, the URL “www.blackhaircare.com” was initially ranked in tenth place in the unbiased list shown in Table 4 and had a raw score of about 12% of the number one ranked score and a modest bias of 1.29. However, after applying the Formula 1 bias, “www.blackhaircare.com” has vaulted up to the number one position.

TABLE 5
Formula 2 - Top Ten Biased Search Results for “hair care”

| | | Biased | |
|---|---|---|---|
| Original | Query: hair care | Score | |
| Rank | URL (Formula 2) | (Formula 2) | Bias |
| 24 | http://www.blackhairmedia.com/ | 558083 | 1.433 |
| | hairstyles.htm | | |
| 18 | http://www.jazma.com/ | 543259 | 1.3996 |
| 10 | http://www.blackhaircare.com/ | 370497 | 1.292 |
| 28 | http://www.nappturality.com/ | 365803 | 1.3991 |
| 23 | http://members.aol.com/horizon011/ | 269302 | 1.3412 |
| | hair/index.html | | |
| 26 | http://www.nappyhair.com/ | 165044 | 1.3075 |
| 63 | http://www.afrohair.com/styles | 154586 | 1.4388 |
| 54 | http://www.blackhairmedia.com/ | 130699 | 1.3968 |
| 31 | http://www.africanwonders.com/ | 127757 | 1.3095 |
| 44 | http://www.ourhair.net/ | 119952 | 1.3513 |

Table 5 illustrates another African-American biased output data set 54 utilizing Formula 2 where the Q value is about one. Again, the search results are ranked according to the Formula 2 biased score shown in the third column. The bias ratio, URL, and original rank are shown in Table 5.

It should be noted that Formula 2 has pulled results from even deeper within the original rankings than the results biased by Formula 1. The previously mentioned URL “www.blackhaircare.com” has moved to the number three position while originally lower ranked URL links have moved to the number one and two positions.

Formula 2 has provided a more aggressive approach to demographic biasing by moving results farther down the original list into the top ten results of the final biased search results 32.

FIG. 3 shows a synchronization process 66 of the biased output data set 54 with a Loser-Winner Map 88. The optimization module 56 implements the synchronization process 66 to eliminate duplicate results and ensures that the URLs being provided in the biased search results 32 are of the highest quality.

The Loser-Winner Map 88 indicates which URL, between more than one live URL, has the highest quality. The winner URL is considered to be a URL that is of good quality, is more popular, and contains more desirable content. For every loser URL, there is an equivalent winner URL that is considered to be of better quality and more popular. Therefore, winner URLs are chosen for the biased search results 32 and duplicate loser URLs of lower quality are eliminated from the biased search results 32 reflecting the ranking prescribed in the biased output data set 54.

FIG. 3 further shows the biased search results 32 being loaded to a demographic bias server 70. In addition, the biased search results 32 can be submitted for further processing 72 where search results 32 may be further adjusted, normalized, scaled, or filtered.

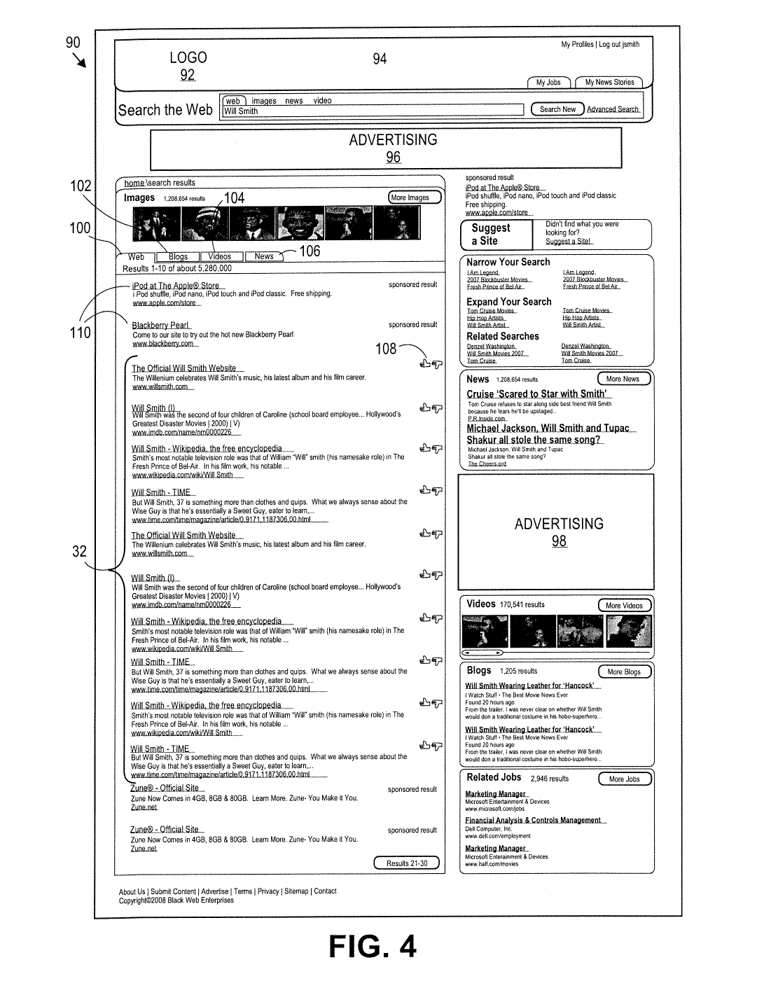

FIG. 4 illustrates a screenshot 90 of a user interface displaying search results, according to an embodiment. A logo 92 and search box 94 are presented to the user where a user can enter a search query 22 and search the world-wide web. An advertising box 96 is located below the search box 94 and a second advertising box 98 can be located in a right hand column of the web page.

Search results 32 are shown in a web tab 100 where a user can select the type of content desired. A blog tab 102, video tab 104, and news tab 106 are alternatively provided for user interaction. The geo-bias system 38 can search for content depending on what type of tab is selected by the user, according to an embodiment.

For example, the screen shot shows a query containing the search term “Will Smith” producing search results 32 from a search conducted via the entire web. The search results 32 can be biased or unbiased according to a demographic criteria. However, according to an embodiment, a user may select the news tab 106 and biased news search results may be produced based on the query 22.

The top two URL links are sponsor links 110 located just above the search results 32. A rating system 108 can be provided so that the user can rate a URL link depending on whether it was helpful or seems to match the user's preference.

The user interface can be provided with an adjustment mechanism to adjust the amount of demographic bias desired (such as adjusting P and Q factors). Click scores can be weighted and results customized by the present invention for any substantial segment that is not homogenously distributed and for which population distribution information is available at the state or town level.

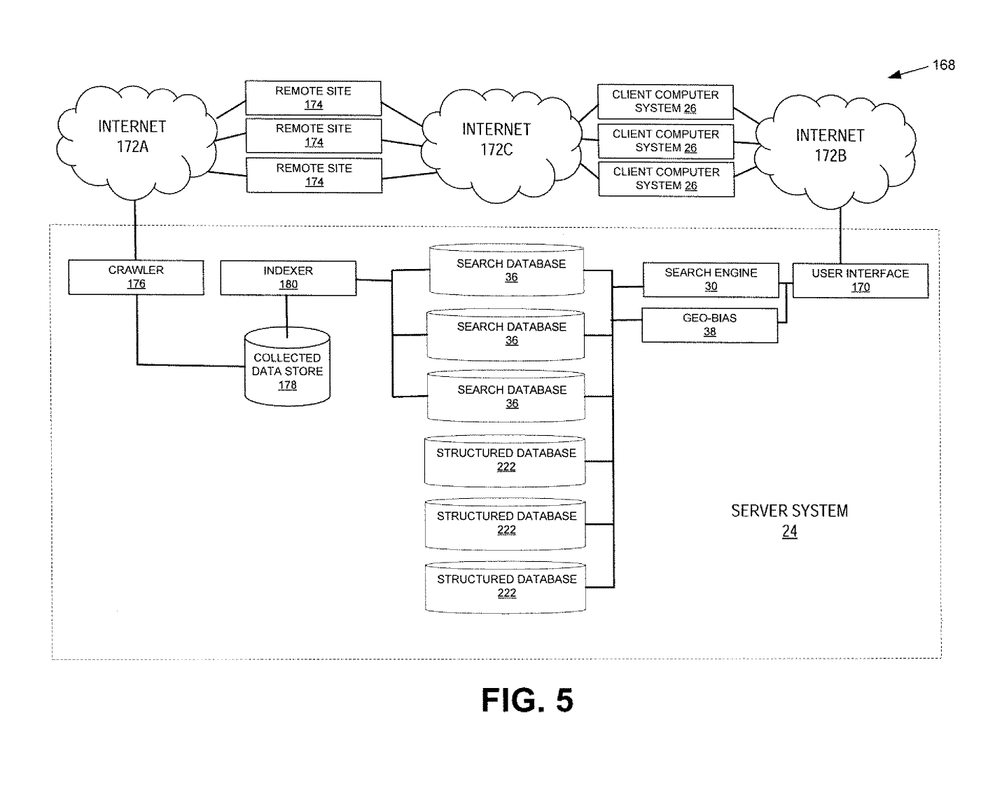

FIG. 5 of the accompanying drawings illustrates a network environment 168 that includes a user interface 170, according to an embodiment of the invention, including the internet 172A, 172B and 172C, a server computer system 24, a plurality of client computer systems 26, and a plurality of remote sites 174.

The server computer system 24 has stored thereon a crawler 176, a collected data store 178, an indexer 180, a plurality of search databases 36, a plurality of structured databases and data sources 222, a search engine 30, a geo-bias system 38, and the user interface 170. The novelty of the present invention revolves around the user interface 170, the search engine 30, the geo-bias system 38, and one or more of the structured databases and data sources 222. The crawler 176 is connected over the internet 172A to the remote sites 174. The collected data store 178 is connected to the crawler 176, and the indexer 180 is connected to the collected data store 178. The search databases 36 are connected to the indexer 180. The search engine 30 and geo-bias system 38 are connected to the search databases 36 and the structured databases and data sources 222. The client computer systems 26 are located at respective client sites and are connected over the internet 172B and the user interface 170 to the search engine 30 and geo-bias system 38.

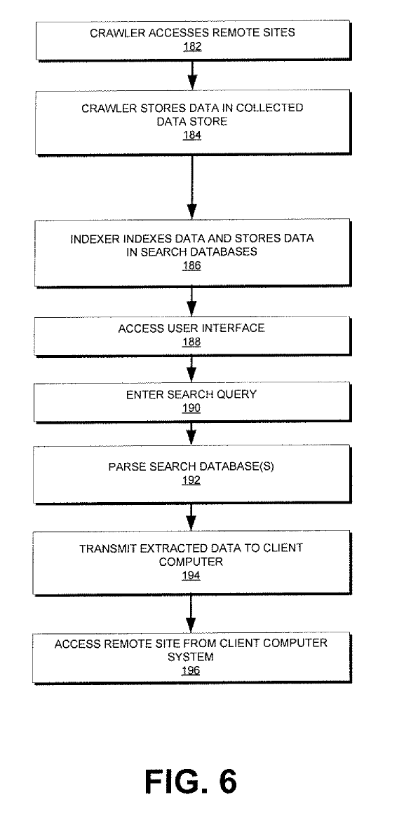

Reference is now made to FIGS. 5 and 6 in combination to describe the functioning of the network environment 168. The crawler 176 periodically accesses the remote sites 174 over the internet 172A (step 182). The crawler 176 collects data from the remote sites 174 and stores the data in the collected data store 178 (step 184). The indexer 180 indexes the data in the collected data store 178 and stores the indexed data in the search databases 36 (step 186). The search databases 36 may, for example, be a “Web” database, a “News” database, a “Blogs & Feeds” database, an “Images” database, etc. The structured databases or data sources 222 are licensed from third party providers and may, for example, include an encyclopedia, a dictionary, maps, a movies database, etc.

A user at one of the client computer systems 26 accesses the user interface 170 over the internet 172B (step 188). The user can enter a search query in a search box in the user interface 170, and either hit “Enter” on a keyboard or select a “Search” button or a “Go” button of the user interface 170 (step 190). The search engine 30 then uses the “Search” query to parse the search databases 36 or the structured databases or data sources 222. In the example of where a “Web” search is conducted, the search engine 30 and geo-bias system 38 parse the search database 36 having general Internet Web data (step 192). Various technologies exist for comparing or using a search query to extract data from databases, as will be understood by a person skilled in the art.

The search engine 30 and/or geo-bias system 38 then transmit the extracted data over the internet 172B to the client computer system 26 (step 194). The extracted data includes URL links to one or more of the remote sites 174. The user at the client computer system 26 can select one of the links to the remote sites 174 and access the respective remote site 174 over the internet 172C (step 196). The server computer system 24 has thus assisted the user at the respective client computer system 26 to find or select one of the remote sites 174 that have data pertaining to the query entered by the user.

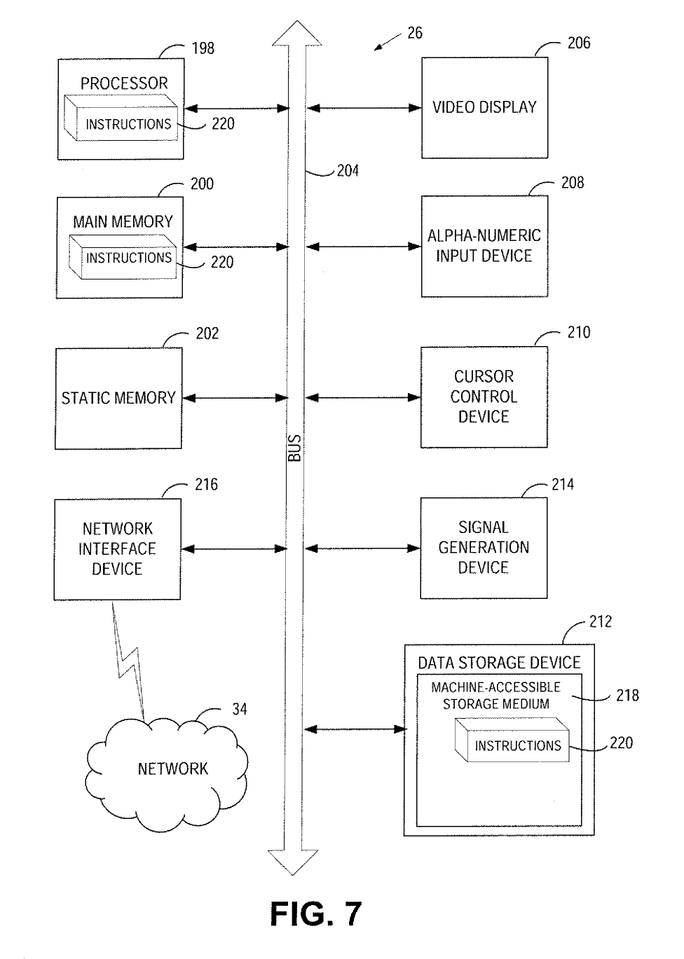

FIG. 7 shows a diagrammatic representation of a machine in the exemplary form of one of the client computer systems 26 within which a set of instructions, for causing the machine to perform any one or more of the methodologies discussed herein, may be executed. In alternative embodiments, the machine operates as a standalone device or may be connected (e.g., network) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term (machine) shall be taken to include any collection of machines that individually or jointly execute a set (or multiple sets) of instructions to perform any one or more of the methodologies discussed herein. The server computer system 24 of FIG. 5 may include one or more machines as shown in FIG. 7.

The exemplary client computer system 26 includes a processor 198 (e.g., a central processing unit (CPU), a graphics processing unit (GPU), or both), a main memory 200 (e.g., read-only memory (ROM), flash memory, dynamic random access memory (DRAM) such as synchronous DRAM (SDRAM) or Rambus DRAM (RDRAM), etc.), and a static memory 202 (e.g., flash memory, static random access memory (FRAM), etc.), which communicate with each other via a bus 204.

The client computer system 26 may further include a video display 206 (e.g., a liquid crystal display (LCD) or a cathode ray tube (CRT)). The client computer system 26 includes an alpha-numeric input device 208 (e.g., a keyboard), a cursor control device 210 (e.g., a mouse), a disk drive unit 212, a signal generation device 214 (e.g., a speaker), and a network interface device 216.

The disk drive unit 212 includes a machine-readable medium 218 on which is stored one or more sets of instructions 220 (e.g., software) embodying any one or more of the methodologies or functions described herein. The software may reside, completely or at least partially, within the main memory 200 and/or within the processor 198 during execution thereof by the client computer system 26, the memory 200 and the processor 198 also constituting machine readable media. The software may further be transmitted or received over a network 154 via the network interface device 216.

While the instructions 220 are shown in an exemplary embodiment to be on a single medium, the term “machine readable medium” should be taken to understand a single medium or multiple media (e.g., a centralized or distributed database or data source and/or associated caches and servers) that store the one or more sets of instructions. The term “machine readable medium” shall be taken to include any storage medium that is capable of storing, encoding, or carrying a set of instructions for execution by the machine and that caused the machine to perform any one or more of the methodologies of the present invention. The term “machine readable medium” shall accordingly be taken to include, but not be limited to, solid-state memories, and optical and magnetic media.

It is understood that the geo-bias system 38 can be integrated with a search engine or can operate separately from a search engine system,

In an alternative embodiment, the geo-bias system 38 can be applied to specific searches of news feeds, blogs, and video content in addition to general web content.

In an alternative embodiment, the demographic criteria or segment could include (but is not limited to) ethnic categories, country of origin, religious affiliation, political party affiliation, organization membership, family make-up, education level, housing level, or product ownership.

In another alternative embodiment, instead of using clicks or hits, the present invention can be applied to any observable user action such as queries. By calculating the bias for queries, for example, it is possible to present related queries as suggestions that are highly relevant to the target user segment.

In yet another alternative embodiment, the present invention can be applied to identify user preferences such as popular queries, web destinations, topics, or other preferences for the target population segment. The bias data can be valuable in associating data to provide better tailored service to a user.

In another alternative embodiment, multiple dimensions of population segmentation can be applied simultaneously. For example, it is possible to calculate a segment bias for African-Americans and a separate segment bias for home owners, thereafter applying a combination function on the two biases for users who belong to both segments.

In another alternative embodiment, clicks can be declined the full demographic weight if they tend to come mostly from a single location, under the assumption that their concentration represents a local bias rather than a demographic bias.

One advantage of the present invention is that as long as there is sufficient skew in the geographical distribution of the target group, and as long as there is sufficient click data, the present invention is quite robust to the presence of noise in the data.

Another advantage is that the demographic segment need not be explicitly determined for the source of each click, but rather each click can be assigned a probability of being from a user in a given demographic group based on its source location. The present invention allows customized results to be created for many demographic segments based on historical click behavior without any requirement for explicit demographic information to be assigned to the clicks.

Another advantage is that a majority of users would be satisfied with the biased search results and overall satisfaction with search results would be increased. However, because no segment is made up of people with homogenous preferences, not every user would be pleased with this arrangement.

Another advantage is that local biases are eliminated from the search results. For example, if URL1 received 75% of its clicks from town A, having a large African-American population, and URL2 received 75% of its clicks from town B (having a relatively small African-American population), then URL1 would be listed first for African-American users. There could be local reasons aside from ethnicity as to why URL1 is preferred in town A, but in application, the clicks will generally be summed over a plethora of varied locations, eliminating local biases and retaining the common biases that link those diverse source locations. Another advantage is that multiple client computer systems located in different locations having the same demographic characteristics will receive the same search results. Therefore, a first query from a first group of client computer systems and a second query from a second group of client computer systems will receive the same search results because of a common demographic criteria, even though the client computer systems are located in different geographic locations. In another example, the first and second group of client computer systems can receive the same search results based purely on a common geographic location or region.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of data processing comprising:
receiving a query from a client computer system over a network at a server computer system;
utilizing the query to extract at least one search result from a data source;
associating the at least one search result with a geographically distributed population;
associating at least one demographic criteria with the geographically distributed population;
processing the at least one search result to create at least one biased search result based on the at least one demographic criteria; and
transmitting the at least one biased search result from the server computer system to the client computer system.

2. The method of claim 1, wherein the processing of the at least one search result is accomplished by a geo-bias process.

3. The method of claim 2, wherein the geo-bias process includes determining demographic hits for at least one URL by summing a product of a percentage of a population in at least one geographic location that fits the demographic criteria and a number of hits for the at least one URL.

4. The method of claim 3, wherein the geo-bias process further includes determining a bias ratio for a URL based on expected hits and the demographic hits to determine whether a URL is uniquely relevant to a demographic segment fitting the demographic criteria.

5. The method of claim 2, wherein the geo-bias process considers the volume of user clicks by providing at least one adjustment factor.

6. The method of claim 5, wherein the geo-bias process includes a dampening factor.

7. The method of claim 4, wherein the bias ratio is applied to at least one raw log score to create the at least one biased search result wherein the at least one raw log score is adjusted based on the at least one demographic criteria.

8. The method of claim 1, wherein the geographically distributed population is determined by an Internet Protocol address.

9. The method of claim 1, wherein the at least one demographic criteria is political party affiliation.

10. The method of claim 1, wherein the at least one demographic criteria is related to at least one of Asian-Americans, Latin-Americans, and African-Americans.

11. The method of claim 1, wherein the at least one search result is ranked differently depending on the at least one demographic criteria.

12. A method of data processing comprising:
receiving a first query from a first group of client computer systems at a server computer system;
receiving a second query from a second group of client computer systems at the server computer system;
utilizing the first and second query to extract at least one search result from a data source;
associating the at least one search result with a geographically distributed population;
associating at least one demographic criteria with the geographically distributed population;
processing the at least one search result to create a first output data set and second output data set based on the at least one demographic criteria;
transmitting a first output data set from the server computer system to the first group of client computer systems; and
transmitting a second output data set from the server computer system to the second group of client computer systems, wherein the first output data set and second output data set are the same because the first group of client computer systems and second group of client computer systems have the same geographically distributed user population.

13. The method of claim 12, wherein the first and second group of client computer systems are located in different geographic locations.

14. The method of claim 12, wherein the first and second group of client computer systems are located in the same geographic location.

15. The method of claim 12, wherein the associating at least one demographic criteria with the geographically distributed population is accomplished by a geo-bias process.

16. The method of claim 15 wherein the geo-bias process includes determining demographic hits for at least one URL by summing a product of a percentage of a population in at least one geographic location that fits the demographic criteria and a number of hits for the at least one URL

17. The method of claim 12, wherein the first and second query are the same.

18. A machine-readable storage medium that provides executable instructions which, when executed by a computer system, cause the computer system to perform a method comprising:
receiving a query from a client computer system over a network at a server computer system;
utilizing the query to extract at least one search result from a data source;
associating the at least one search result with a geographically distributed population;
associating at least one demographic criteria with the geographically distributed population;
processing the at least one search result to create at least one biased search result based on the at least one demographic criteria; and
transmitting the at least one biased search result from the server computer system to the client computer system.

19. A machine-readable storage medium that provides executable instructions which, when executed by a computer system, cause the computer system to perform a method comprising:
receiving a first query from a first group of client computer systems at a server computer system;
receiving a second query from a second group of client computer systems at the server computer system;
utilizing the first and second query to extract at least one search result from a data source;
associating the at least one search result with a geographically distributed population;
associating at least one demographic criteria with the geographically distributed population;
processing the at least one search result to create a first output data set and second output data set based on the at least one demographic criteria;
transmitting a first output data set from the server computer system to the first group of client computer systems; and
transmitting a second output data set from the server computer system to the second group of client computer systems, wherein the first output data set and second output data set are the same because the first group of client computer systems and second group of client computer systems have the same geographically distributed user population.

20. A system for processing data comprising:
a server computer system;
a receiving module stored on the server computer system for receiving a query;
a search engine that utilizes the query to extract at least one search result from a data source;
a geographic module for associating the at least one search result with a geographically distributed population and associating at least one demographic criteria with the geographically distributed population;
a processing module for processing the at least one search result to create at least one ranked output data set based on the at least one demographic data; and
a transmission module to transmit the at least one ranked output data set, based on the at least one demographic criteria from the server computer system to the client computer system.
